(19) United States
(12) Patent Application Publication
(10) Pub. No.: US 2003/0210279 A1
(43) Pub. Date: Nov. 13, 2003

(54) Shopping system

(75) Inventor: Minoru Masuda, Inagi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/459,436

(22) Filed: Jun. 12, 2003

Related U.S. Application Data
(63) Continuation of application No. PCT/JP00/09311, filed on Dec. 27, 2000.

(51) Int. Cl. G09G 5/00

(52) U.S. Cl. 345/810

(57) ABSTRACT

In a shopping system in which a client purchases a merchandise by accessing a server which controls one or more shops, the server comprises display means for displaying, at the client, a single screen having a merchandise shelf which includes icons of a plurality of merchandises, and a shopping cart, the client comprises selecting means for selecting an icon of a merchandise to be purchased on the screen by a drag-and-drop to put the selected icon in the shopping cart, so as to notify the purchased merchandise to the server, and the display means moves the selected icon of the merchandise from the merchandise shelf into the shopping cart, displays a balance between a budget and a total cost of the merchandises within the shopping cart with a format visually recognizable on the single screen, and displays a display urging input of the budget on the single screen or on a different screen.

### TECHNICAL FIELD

The present invention generally relates to shopping systems, and more particularly to a shopping system for shops on the Internet.

### BACKGROUND ART

First, a description will be given of a conventional shopping system. FIGS. 1 through 3 are diagrams for explaining conventional operations when shopping in shops on the Internet.

The user makes access to a www server which manages the shops from a www browser, so as to make access to a desired shop. Hence, a merchandise (article) list by category (genre) shown in FIG. 1, for example, is displayed on a screen at the user. This merchandise list by category includes merchandise names, prices and the like.

When the user selects a merchandise which is to be purchased and has a merchandise name AA from the merchandise list by category by clicking a mouse, for example, a merchandise description shown in FIG. 2 is displayed on the screen. The merchandise description includes the external appearance of the selected merchandise, price, description and the like. The user confirms the merchandise description and clicks a “to shopping cart” button by the mouse if this merchandise is to be purchased, thereby putting the selected merchandise into the shopping cart and determining the purchase.

In this type of the so-called shopping cart method, information related to the merchandises which are to be purchased and put into the shopping cart is displayed on the screen in the form of a purchased merchandise list shown in FIG. 3. The purchased merchandise list includes the merchandise name, unit price, number, total and the like. When canceling the purchase of a merchandise, a corresponding “delete” button is clicked by the mouse.

However, in the conventional shopping system employing the shopping cart method, even when the merchandise to be purchased is selected and put into the shopping cart, the feeling is completely different from purchasing the merchandise in the real world, and it is difficult for the user to actually realize the purchased merchandises particularly when a large number of merchandises are purchased. This is because the merchandises to be purchased are selected from the merchandise list by category shown in FIG. 1, the purchase is determined by confirming the merchandise description shown in FIG. 2, and the information related to the merchandises which are to be purchased and put into the shopping cart is displayed on the screen in the form of the purchased merchandise list shown in FIG. 3. Accordingly, in the conventional shopping system, there was a problem in that the user cannot shop with a feeling similar to that when purchasing merchandises in the real world.

On the other hand, particularly when purchasing a large number of merchandises, the user in many cases has a budget, that is, a spending limit. However, in the conventional shopping system, it is possible to know the total cost of the merchandises to be purchased from the purchased merchandise list shown in FIG. 3, but the user himself must judge whether or not the spending limit is exceeded. In addition, if the total cost of the merchandises to be purchased exceeds the spending limit, the user may cancel the purchase of one merchandise, for example, but the user himself must once again judge whether or not the total cost as a result of this cancellation exceeds the spending limit. Moreover, the user himself must also judge how much higher or lower the total cost of the purchased merchandises is with respect to the spending limit. For these reasons, when the user shops in the conventional shopping system by determining the spending limit, the user himself must constantly be aware of the relationship between the total cost of the purchased merchandises and the spending limit, and there was a problem in that the load on the user is large and inconvenient.

### DISCLOSURE OF THE INVENTION

Accordingly, it is a general object of the present invention to provide a novel and useful shopping system in which the problems described above are eliminated.

A first object of the present invention is to provide a shopping system which enables shopping in shops on the Internet with a feeling similar to that when purchasing merchandises in the real world.

In addition, a second object of the present invention is to provide a shopping system which enables display of a relationship between a total cost of merchandises to be purchased and a spending limit with a format easily understood by the user, when shopping in shops on the Internet.

A more particular object of the present invention is to provide a shopping system in which a client purchases a merchandise by accessing a server which controls one or more shops, wherein the server comprises display means for displaying, at the client, a single screen having a merchandise shelf which includes icons of a plurality of merchandises, and a shopping cart; the client comprises selecting means for selecting an icon of a merchandise to be purchased on the screen by a drag-and-drop to put the selected icon in the shopping cart, so as to notify the purchased merchandise to the server; and the display means moves the selected icon of the merchandise from the merchandise shelf into the shopping cart, displays a balance between a budget and a total cost of the merchandises within the shopping cart with a format visually recognizable on the single screen, and displays a display urging input of the budget on the single screen or on a different screen. According to the present invention, it is possible to shop in shops on the Internet with a feeling similar to that when purchasing merchandises in the real world, and the first and second objects described above are achieved.

Still another object of the present invention is to provide a shopping system in which a client purchases a merchandise by accessing a server which controls one or more shops, wherein the server comprises display means for displaying, at the client, a balance between a budget which is input at the client and a total cost of merchandises which are to be purchased and selected at the client, with a visually recognizable format on a screen. According to the present invention, it is possible to display a relationship between the total cost of the merchandises to be purchased and a spending limit with a format easily recognizable by the user, when shopping in shops on the Internet, and the second object described above can be realized.

A further object of the present invention is to provide an information terminal which forms a client in a shopping system in which the client purchases merchandises by making access to a server which manages one or more shops and displays on a single screen at the client a merchandise shelf including icons of a plurality of merchandises and a shopping cart, comprising selecting means for selecting an icon of a merchandise to be purchased on the single screen by a drag-and-drop to put the selected icon in the shopping cart, so as to notify the purchased merchandise to the server; and display means, responsive to the server, for moving the selected icon of the merchandise from the merchandise shelf into the shopping cart to display the selected icon in the shopping cart, displaying a balance between a budget and a total cost of the merchandises within the shopping cart with a format visually recognizable on the single screen, and displaying a display urging input of the budget on the single screen or on a different screen. According to the present invention, it is possible to display a relationship between the total cost of the merchandises to be purchased and a spending limit with a format easily recognizable by the user, when shopping in shops on the Internet, and the second object described above can be realized.

Other objects and further features of the present invention will be apparent from the following detailed description when read in conjunction with the accompanying drawings.

### BRIEF DESCRIPTION OF THE DRAWING

FIG. 1 is a diagram for explaining a conventional operation when shopping in shops on the Internet;

FIG. 2 is a diagram for explaining a conventional operation when shopping in the shop on the Internet;

FIG. 3 is a diagram for explaining a conventional operation when shopping in the shops on the Internet;

FIG. 4 is a diagram showing an embodiment of a shopping system according to the present invention;

FIG. 5 is a flow chart for explaining an operation of the embodiment;

FIG. 6 is a flow chart for explaining the operation of the embodiment;

FIG. 7 is a diagram showing a display which is made when a user shops in a shop of a shopping mall;

FIG. 8 is a diagram showing a display which is made when the user shops in the shop of the shopping mall;

FIG. 9 is a diagram showing a display which is made when the user shops in the shop of the shopping mall;

FIG. 10 is a diagram showing a display which is made when the user shops in the shop of the shopping mall;

FIG. 11 is a diagram showing a display which is made when the user shops in the shop of the shopping mall;

FIG. 12 is a diagram showing a display which is made when the user shops in the shop of the shopping mall;

FIG. 13 is a diagram for explaining a size of a shopping cart;

FIG. 14 is a diagram showing a shopping cart list; and

FIG. 15 is a diagram for explaining a modification of a display of a balance between a total cost of merchandises to be purchased and a budget balance.

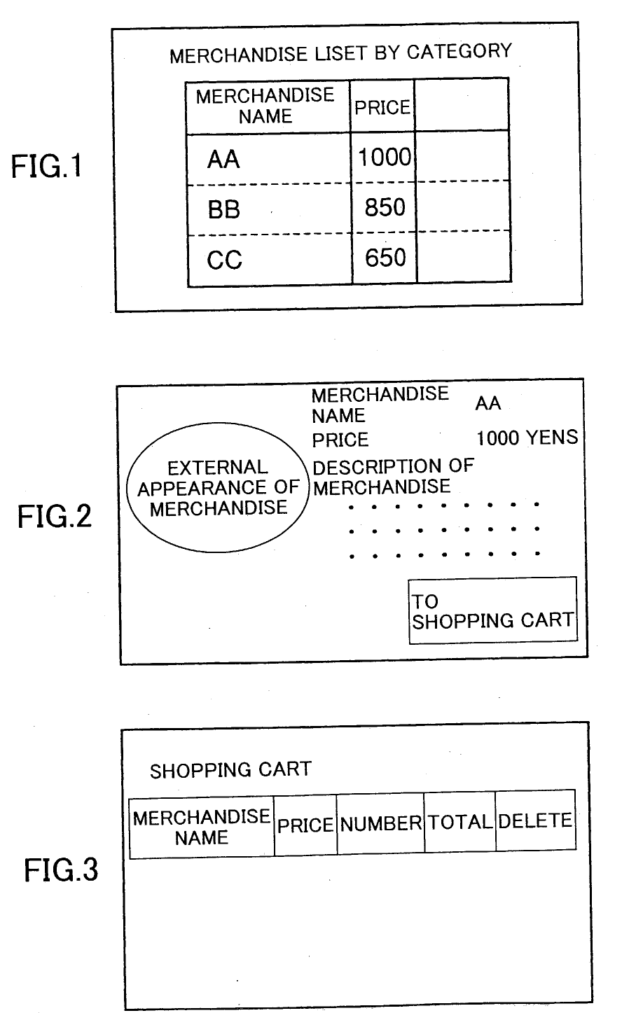

### BEST MODE OF CARRYING OUT THE INVENTION

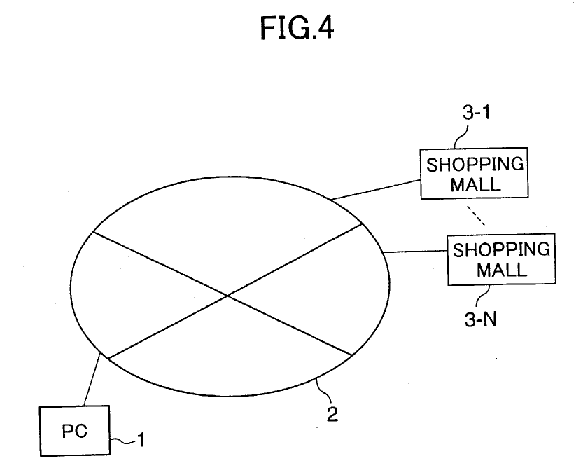

A description will now be given of an embodiment of a shopping system according to the present invention, by referring to FIG. 4 and the subsequent drawings.

FIG. 4 is a diagram showing this embodiment of the shopping system according to the present invention. In FIG. 4, a information terminal 1 which is provided with an Internet function of a personal computer (PC) or the like, that is, a www browser, can make access to any of a plurality of shopping malls 3-1 through 3-N via a network 2 such as the Internet. Each shopping mall 3-i (i=1 to N) has a www server which manages one or a plurality of shops. Of course, a single www server may be provided with respect to a plurality of shopping malls, and furthermore, a single www server may be formed by a plurality of servers. The information terminal 1 itself has a known hardware structure including a CPU, a display part, a storage part, and an input device such as a mouse and a keyboard. Each of the shopping malls 31- through 3-N itself, including the www server, has a known hardware structure including a CPU, a display part, a storage part and an input device. In this embodiment, the information terminal 1 which is operated by a user forms a client of the shopping system, and each of the shopping malls 3-1 through 3-N including the www server forms a server of the shopping system.

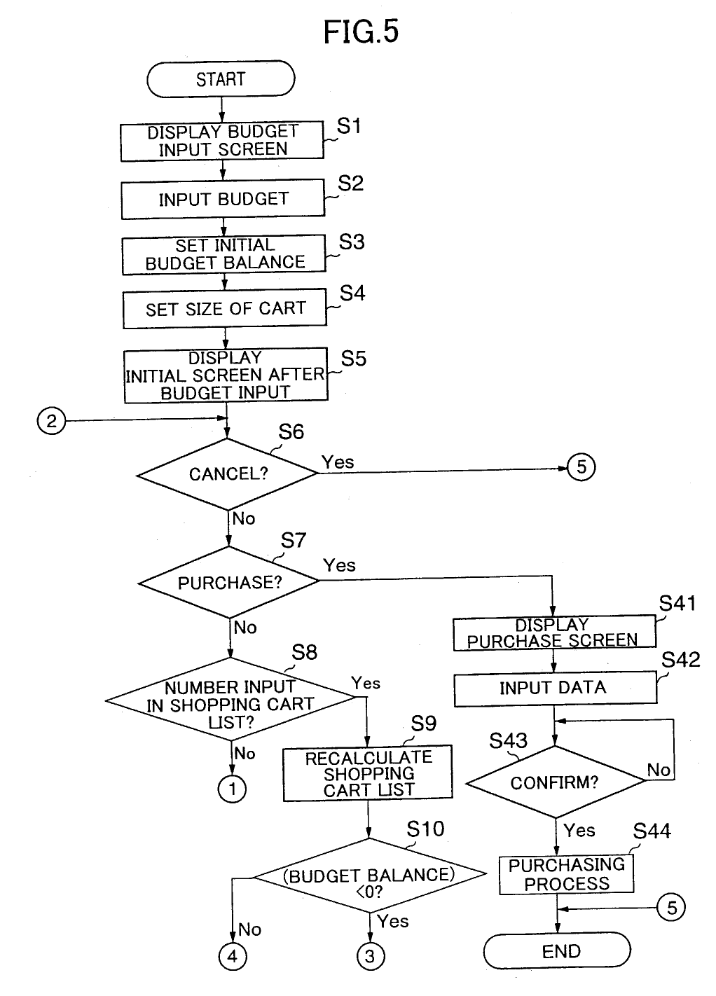

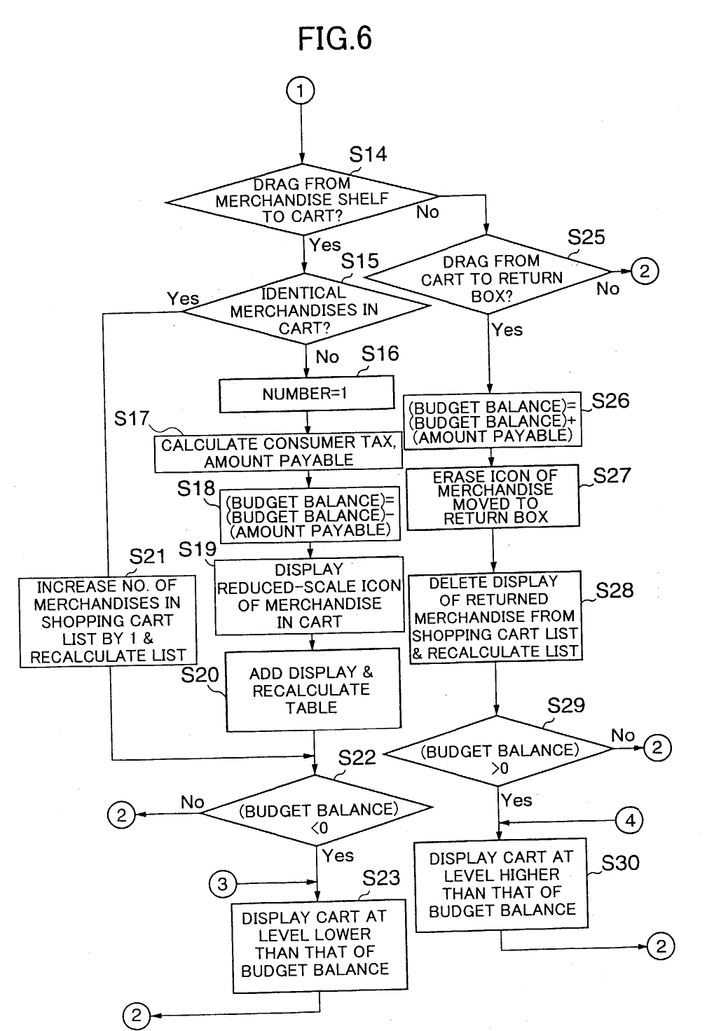

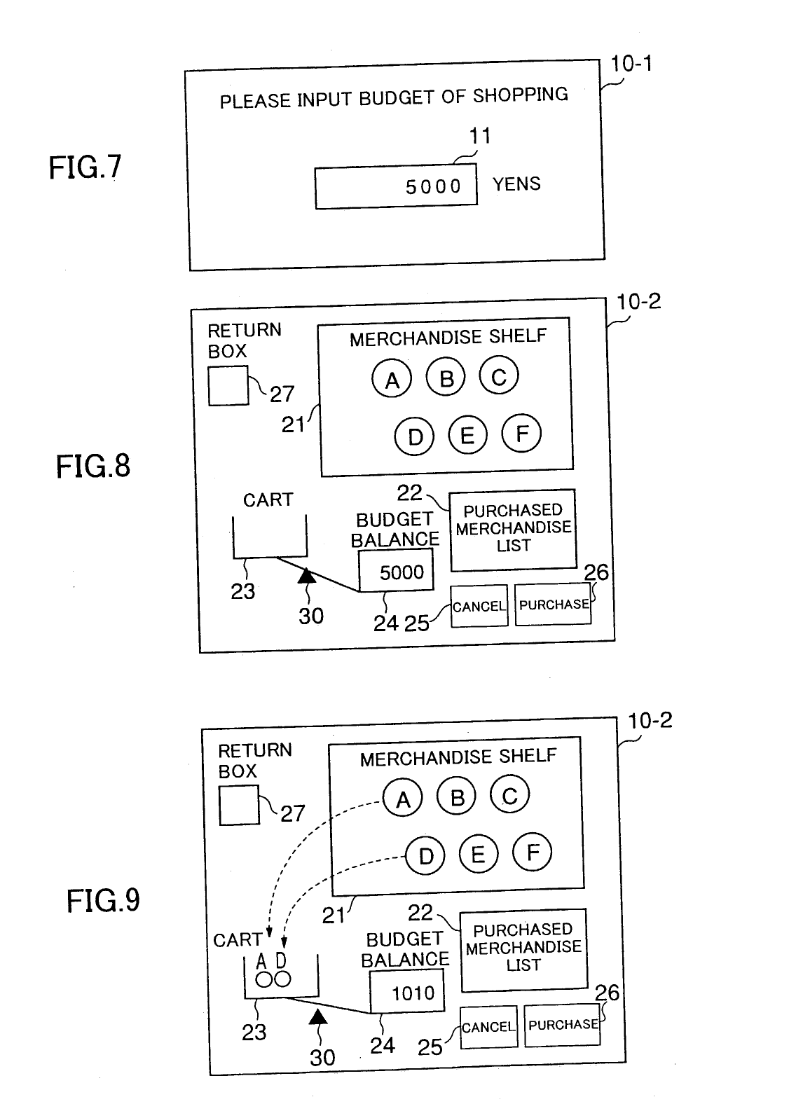

First, a description will be given of a user operation at the information terminal 1 in this embodiment, by referring to FIGS. 5 through 12. FIGS. 5 and 6 are flow charts for explaining the operation of this embodiment. In addition, FIGS. 7 through 12 are diagrams respectively showing a display which is made on the display part of the information terminal 1 when the user shops in a shop of the shopping mall.

In a step S1 shown in FIG. 5, the server displays a budget input screen 10-1 shown in FIG. 7 on the display part of the client. The budget in this case refers to a spending limit of the shopping. In the budget input screen 10-1 shown in FIG. 7, a message “please input budget of shopping” is displayed together with a window 11 for inputting the budget. In a step S2, the user inputs the budget from the input device of the client. When the user inputs 5000 Yens as the budget, for example, 5000 Yens is displayed within the window 11 shown in FIG. 7.

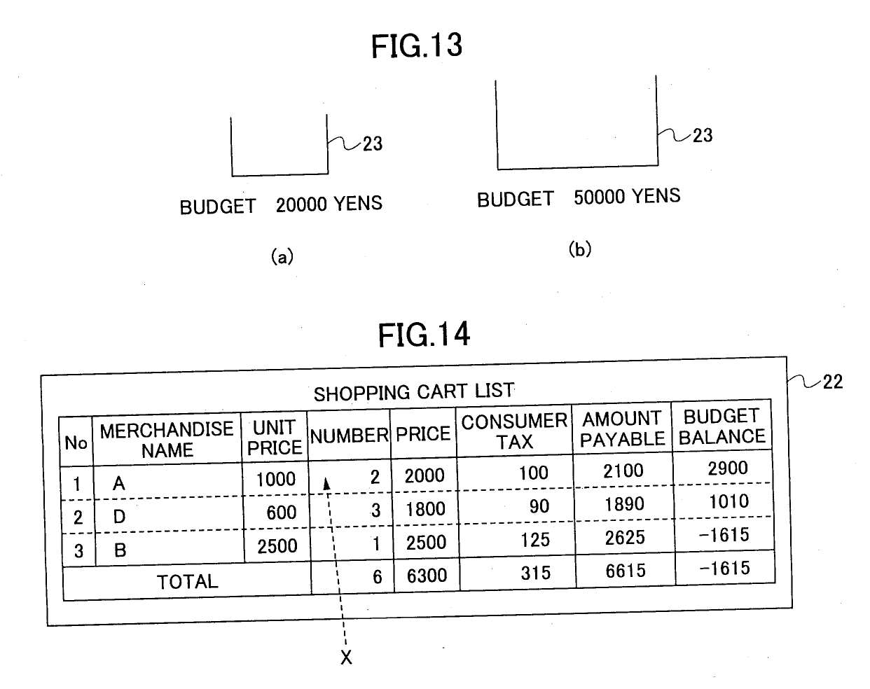

In a step S3, the server sets an initial budget balance. This initial budget balance is equal to the budget described above. In a step S4, the server sets a size of a shopping cart 23 within a screen 10-2 shown in FIG. 8 which is displayed on the display part of the client and will be described later, depending on the budget. FIG. 13 is a diagram for explaining the size of the shopping cart 23. In FIG. 13, (a) shows the shopping cart 23 for a case where the budget is 2000 Yens, and (b) shows the shopping cart 23 for a case where the budget is 5000 Yens. In other words, the larger the budget, the larger the shopping cart 23 that is displayed, so that icons of more merchandises can be put into the shopping cart 23. In addition, in a step S5, the server displays an initial screen after the input of the budget on the display part of the client. In the initial state, the shopping cart 23 is displayed at a level higher than the display of a budget balance within a window 24 which is displayed within the same screen 10-2.

The initial budget balance is equal to the budget described above. Hence, at the client, the budget is displayed as the budget balance within the window 24 of the screen 10-2 shown in FIG. 8 after the input of the budget. In addition to the window 24, a merchandise shelf 21, a purchased merchandise list 22, the shopping cart 23, a cancel button 25, a purchase button 26, a return box 27 and a scale 30 are displayed on this screen 10-2.

Icons of merchandises A through F are displayed within the merchandise shelf 21. The icons of the merchandises A through F are photographs, illustrations, animations or the like of the external appearances of the corresponding merchandises A through F, so that each of the merchandises A through F can be identified from the corresponding icon. The icon itself may be a still picture or a motion picture. A list of merchandises to be purchased is displayed within the purchased merchandise list 22. The purchased merchandise list 22 includes merchandise names, prices and the like. The merchandises to be purchased are put into the shopping cart 23, and the shopping cart 23 has functions similar to a shopping cart in the real world. As will be described later, the merchandise to be purchased is moved (copied) from the merchandise shelf 21 into the shopping cart 23 when the user makes a drag-and-drop of the icon corresponding to the merchandise to be purchased using the mouse. The budget balance which is obtained by subtracting a total cost of the merchandises to be purchased from the budget, is displayed within the window 24. In this embodiment, the shopping cart 23 and the window 24 are displayed with a format balanced by the scale 30. In other words, a balance between the total cost of the merchandises which are to be purchased and displayed by the corresponding icons within the shopping cart 23 and the budget balance which is displayed within the window 24 is displayed by the scale 30, so that the one with the smaller amount rises (that is, displayed at a higher level) relative to the other on the scale 30.

The user selects the cancel button 25 by clicking the cancel button 25 by the mouse, for example, when canceling the operation. The user selects the purchase button 26 by clicking the purchase button 26 by the mouse, for example, when determining the purchase of the merchandise which is moved from the merchandise shelf 21 to the shopping cart 23. The return box 27 is used to return the merchandise which is to be purchased back to the merchandise shelf 21. The merchandise which is to be purchased is returned to the merchandise shelf 21 when the user makes a drag-and-drop of the icon corresponding to this merchandise from the shopping cart 23 to the return box 27. Of course, it is possible to return the merchandise to be purchased to the merchandise shelf 21 by making a drag-and-drop of the icon corresponding to this merchandise from the shopping cart 23 directly to the merchandise shelf 21. However, in a case where a plurality of merchandise shelves 21 exist and are selectively displayed within the screen 10-2, the merchandise shelf 21 to which the merchandise is to be returned may not be displayed within the screen 10-2, and in such a case, it is more convenient to provide and use the return box 27.

Returning now to the description of FIG. 5, in a step S6, the server decides whether or not the cancel button 25 is selected at the client. The process is forcibly ended if the decision result in the step S6 is YES. On the other hand, if the decision result in the step S6 is NO, in a step S7, the server decides whether or not the purchase button 26 is selected at the client. If the decision result in the step S7 is NO, in a step S8, the server decides whether or not a number of merchandises is input at the client on a purchased merchandise list (or shopping cart list) 22 which will be described later. The process advances to a step S14 shown in FIG. 6 if the decision result in the step S8 is NO.

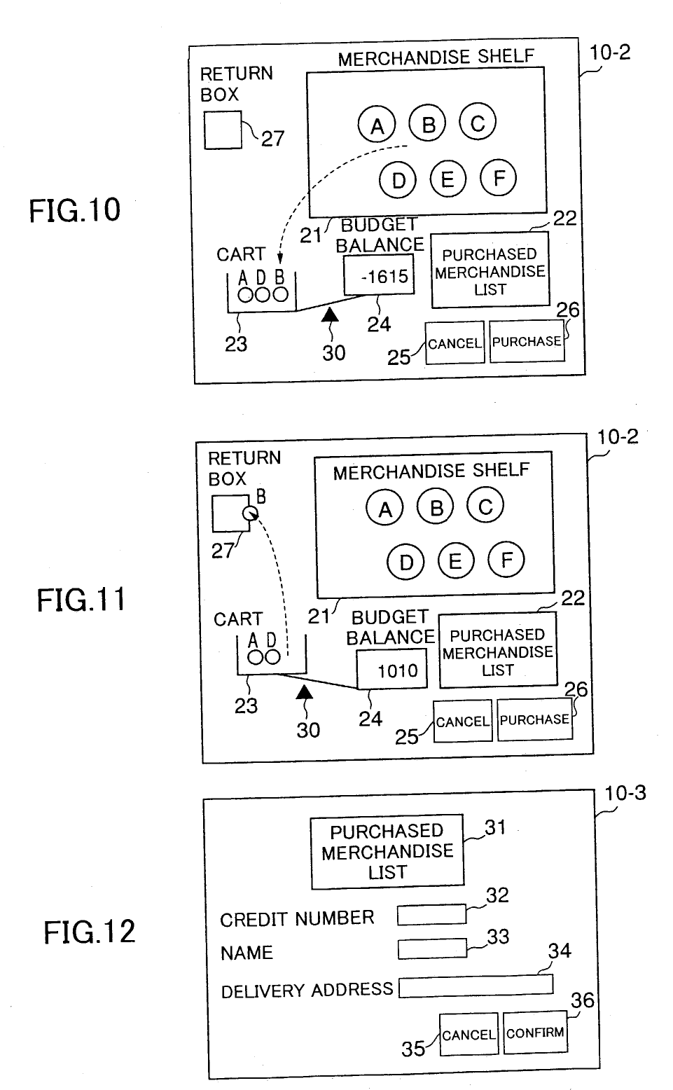

In the step S14 shown in FIG. 6, the server decides whether or not the user made a drag-and-drop of the merchandise from the merchandise shelf 21 to the shopping cart 23 at the client, based on a notification from the client. FIG. 9 shows a state where the merchandises A and D are moved from the merchandise shelf 21 to the shopping cart 23, and FIG. 10 shows a state where the merchandise B is further moved from the merchandise shelf 21 to the shopping cart 23. If the decision result in the step S14 is YES, in a step S15, the server decides whether or not identical merchandises exist within the shopping cart 23. If the decision result in the step S15 is NO, in a step S16, the server sets the number of each merchandise within the shopping cart 23 to 1.

In a step S17, the server calculates an amount payable for the merchandise to be purchased, based on the price of the merchandise and the consumer tax. In a step S18, the server updates the budget balance by subtracting the amount payable from the present budget balance, and displays the updated budget balance within the window 24. In a case where a plurality of merchandises are to be purchased, a total of amounts payable for each of the merchandises, that is, the total cost of the merchandises, is subtracted from the present budget balance so as to update the budget balance. In addition, in a step S19, the server displays the icon of each merchandise which is moved from the merchandise shelf 21 to the shopping cart 23 by the drag-and-drop, in the screen 10-2 which is displayed on the display part of the client, so that the icon is displayed within the shopping cart 23 on a reduced scale compared to the same icon displayed within the merchandise shelf 21. By displaying the icons of the merchandises which are to be purchased within the shopping cart 23, the user can easily confirm the merchandises which are to be purchased by simply looking inside the shopping cart 23, thereby giving the user a feeling of shopping using the shopping cart in the real world.

In a step S20, the server adds to the shopping cart list 22 the display of the merchandises which are to be purchased and are displayed within the shopping cart 23, and recalculates the table (list) in the shopping cart list 22 based on calculation results of the steps S17 and S18, before the process advances to a step S22. On the other hand, if the decision result in the step S15 is YES, in a step S21, the server increases the number of the corresponding merchandise in the shopping cart list 22 by 1, and recalculates the table in the shopping cart list 22, before the process advances to the step S22.

FIG. 14 is a diagram showing the shopping cart list 22. The shopping cart list 22 includes the merchandise name, unit price, number, prices (cost), consumer tax, amount payable, budget balance and the like with respect to each merchandise which is to be purchased and is displayed within the shopping cart 23.

In the step S22, the server decides whether or not the budget balance is 0 or less, and the process returns to the step S6 shown in FIG. 5 if the decision result is NO. On the other hand, if the decision result in the step S22 is YES, in a step S23, the server displays the shopping cart 23 within the screen 10-2 at a level lower than the display position of the budget balance within the window 24, as shown in FIG. 10, and the process returns to the step S6 shown in FIG. 5.

If the decision result in the step S14 is NO, in a step S25, the server decides whether or not the user at the client made a drag-and-drop of the merchandise which is to be returned, from the shopping cart 23 to the return box 27, based on a notification from the client. If the decision result in the step S25 is NO, the process returns to the step S6 shown in FIG. 5. FIG. 11 shows a state where the merchandise B is moved from the shopping cart 23 to the return box 27. By moving the merchandise B to the return box 27, the display within the screen 10-2 returns to the state shown in FIG. 9.

If the decision result in the step S25 is YES, in a step S26, the server adds the amount payable for the returned merchandise to the present budget balance so as to update the budget balance, and displays the updated budget balance within the window 24. When a plurality of merchandises are returned, the budget balance is updated by adding the amounts payable for each of the merchandises, that is, the total cost of the merchandises, to the present budget balance. In addition, in a step S27, the server erases the display of the icon of the merchandise which is moved to the return box 27, from the shopping cart 23. In a step S28, the server deletes from the shopping cart list 23 the display of the merchandise which is returned from the shopping cart 23, and recalculates the table in the shopping cart list 22, before the process advances to a step S29.

In the step S29, the server decides whether or not the budget balance is 0 or greater, and the process returns to the step S6 shown in FIG. 5 if the decision result is NO. On the other hand, if the decision result in the step S29 is YES, in a step S30, the server displays the shopping cart 23 within the screen 10-2 at a level higher than the display position of the budget balance within the window 24, as shown in FIGS. 9 and 10, and the process returns to the step S6 shown in FIG. 5.

When inputting the number of merchandises in the shopping cart list 22 at the client, the number may be input directly in a number column of the shopping cart list 22 as indicated by a dotted arrow X in FIG. 14 or, the same merchandise may be moved from the merchandise shelf 21 to the shopping cart 23 by making the drag-and-drop a plurality of times. When the number of merchandises is input and the decision result in the step S8 shown in FIG. 5 becomes YES, a step S9 recalculates the table in the shopping cart list 22 depending on the input number of merchandises. Further, in a step S10, the server decides whether or not the budget balance is 0 or less, and the process advances to the step S23 shown in FIG. 6 if the decision result is YES. On the other hand, if the decision result in the step S10 is NO, the process advances to the step S30 shown in FIG. 6.

In FIG. 5, if the decision result in the step S7 is YES, in a step S41, the server displays a purchase screen 10-3 shown in FIG. 12 on the display part of the client. The purchase screen 10-3 includes a purchased merchandise list 31, a window 32 for inputting a credit number, a window 33 for inputting the user (purchaser) name, a window 34 for inputting a delivery address of the merchandises, a cancel button 35, and a confirmation button 36.

In a step S42, the user inputs data within the windows 32 through 34 at the client while confirming contents of the purchased merchandise list 31. In a step S43, the server decides whether or not the user selected the confirmation button 36 at the client. If the user finally confirms the purchase of the merchandises and selects the confirmation button 36, the decision result in the step S43 becomes YES, and in a step S44, the server carries out a merchandise purchasing process, before the process ends. The merchandise purchasing process is a known process including placing an order for the purchased merchandises and delivering the purchased merchandises, and a description thereof will be omitted. When the cancel button 35 is selected in the purchase screen 10-3, the process is forcibly ended, similarly to the case where the cancel button 25 is selected in the screen 10-2.

Of course, the method of displaying the balance between the total cost of the merchandises to be purchased and the budget balance is not limited to the method of the above described embodiment using the scale 30. Any method of displaying the balance may be used as long as the user can visually recognize the balance.

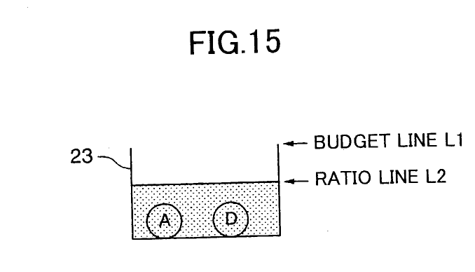

FIG. 15 is a diagram for explaining a modification of the display of the balance between the total cost of the merchandises to be purchased and the budget balance. FIG. 15 shows a state where the icons of the merchandises A and D which are to be purchased are displayed within the shopping cart 23. In this modification, the budget is indicated by a budget line L1 corresponding to the height of the shopping cart 23. In addition, a ratio of the total cost (purchasing cost) of the merchandises to be purchased and the budget is indicated by a ratio line L2. In other words, an occupied area within the shopping cart 23, which is defined by the ratio line L2 and is indicated by a shaded portion, changes depending on the ratio of the total cost (purchasing cost) of the merchandises to be purchased and the budget. A region from a bottom of the shopping cart 23 to the ratio line L2, that is, the occupied area, is displayed by a color, such as green, for example, which is different from the color of other regions of the shopping cart 23. Hence, if the height of the ratio line L2 is less than or equal to the height of budget line L1, it may be recognized that the total cost (purchasing cost) is less than or equal to the budget. In this case, if the height of the ratio line L2 exceeds the height of the budget line L1, it is possible to take measures such as displaying the entire region within the shopping cart 23 in red or, displaying the portion exceeding the budget line L1 in red, so as to indicate that the budged has been exceeded.

Therefore, it is possible to display the balance between the total cost of the merchandises to be purchased and the budget, with a format easily recognizable by the user.

Further, the present invention is not limited to these embodiments, but various variations and modifications may be made without departing from the scope of the present invention.

1. A shopping system in which a client purchases a merchandise by accessing a server which controls one or more shops, wherein:
said server comprises display means for displaying, at the client, a single screen having a merchandise shelf which includes icons of a plurality of merchandises, and a shopping cart;
said client comprises selecting means for selecting an icon of a merchandise to be purchased on the screen by a drag-and-drop to put the selected icon in the shopping cart, so as to notify the purchased merchandise to the server; and
said display means moves the selected icon of the merchandise from the merchandise shelf into the shopping cart, displays a balance between a budget and a total cost of the merchandises within the shopping cart with a format visually recognizable on the single screen, and displays a display urging input of the budget on the single screen or on a different screen.

2. The shopping system as claimed in claim 1, wherein said display means varies a size of the shopping cart depending on the budget.

3. The shopping system as claimed in claim 1 or 2, wherein said display means further displays on the single screen a list of merchandises within the shopping cart.

4. The shopping system as claimed in any of claims 1 to 3, wherein the icons of the merchandises correspond to external appearances of the merchandises.

5. The shopping system as claimed in any of claims 1 to 4, wherein said display means varies an occupied area within the shopping cart depending on the balance between the budget and the total cost of the merchandises to be purchased.

6. A shopping system in which a client purchases a merchandise by accessing a server which controls one or more shops, wherein:
said server comprises display means for displaying, at the client, a balance between a budget which is input at the client and a total cost of merchandises which are to be purchased and selected at the client, with a visually recognizable format on a screen.

7. The shopping system as claimed in claim 6, wherein said display means displays a difference between the budget and the total cost by a numerical value.

8. The shopping system as claimed in claim 6 or 7, wherein said display means displays on the screen a shopping part in which icons of the merchandises to be purchased are displayed, and varies a size of the shopping cart depending on the budget.

9. The shopping system as claimed in claim 8, wherein said display means varies an occupied area within the shopping cart depending on a ratio of the total cost of the merchandises to be purchased and the budget.

10. An information terminal which forms a client in a shopping system in which the client purchases merchandises by making access to a server which manages one or more shops and displays on a single screen at the client a merchandise shelf including icons of a plurality of merchandises and a shopping cart, comprising:
selecting means for selecting an icon of a merchandise to be purchased on the single screen by a drag-and-drop to put the selected icon in the shopping cart, so as to notify the purchased merchandise to the server; and
display means, responsive to the server, for moving the selected icon of the merchandise from the merchandise shelf into the shopping cart to display the selected icon in the shopping cart, displaying a balance between a budget and a total cost of the merchandises within the shopping cart with a format visually recognizable on the single screen, and displaying a display urging input of the budget on the single screen or on a different screen.
